(19) United States
(12) Patent Application Publication
(10) Pub. No.: US 2004/0134584 A1
(43) Pub. Date: Jul. 15, 2004

(54) Pneumatic tire with reinforced bead part

(76) Inventors: Doh-Zong Chung, Kwangju-shi (KR); Bok-Soo Park, Kwangju-shi (KR); Myung-Jin Lee, Kwangju-shi (KR)

Correspondence Address: D. PETER HOCHBERG CO. L.P.A., 1940 EAST 6TH STREET, CLEVELAND, OH, 44114, US

(21) Appl. No.: 10/472,604

(22) PCT Filed: Sep. 13, 2001
(86) PCT No.: PCT/KR01/01540

(51) Int. Cl. B60C 15/00; B60C 15/05; B60C 15/02

(52) U.S. Cl. 152/545; 152/539; 152/552; 152/550

(57) ABSTRACT

The present invention relates to a pneumatic tire with reinforced bead portion which is installed on a rim that does not have flange, and more particularly, to a pneumatic tire wherein bead portion is reinforced by applying rubber lump which is not used in the prior art, wherein said rubber lump (5) which is spirally wound together with carcass ply (3) is placed on the upper portion of two bead (1 and 1′) which are arranged in the bead portion (8), or placed as double rubber lumps and envelop the whole bead (1) so that bead portion (8) of tire is not easily broken away from bead sheet of the rim when air is evacuated from a tire while driving.

### TECHNICAL FIELD

The present invention relates to a pneumatic tire with reinforced bead part installed on a rim without flange and, more particularly, to a pneumatic tire wherein bead part is reinforced by using a lump, which is not used in the prior art, placed between beads so that the bead part is not easily released from the rim of the tire while driving under low air pressure of tire.

### BACKGROUND ART

In conventional pneumatic tires, as shown in the FIG. 1, strong apex 2 is inserted in a bead part 8 where bead is placed, or insert 4 is installed, or the position of the end of carcass ply 3 is changed to reinforce the bead part. By using this method, cornering performance and durability of bead part are enhanced but the comfort of driving a car is reduced. The number 6 in FIG. 1 represents a flange.

In addition, the conventional tire having reinforced bead part has the problem that the tire is easily released from the rim when tire is deflated while driving, when the tire is installed on a rim without flange.

### SUMMARY OF THE INVENTION

The object of the present invention is to solve the problem of bead part of the conventional pneumatic tire. For this object, a rubber lump is installed between beads to prevent the tire from releasing from the rim when the tire is deflated so that car accidents can be prevented.

### BRIEF DESCRIPTION OF DRAWINGS

FIG. 1 is a sectional view of the bead part of a conventional tire,

FIG. 2 is a sectional view of the bead part of a tire according to first embodiment of the present invention,

FIG. 3 is a sectional view of the bead part of a tire according to the second embodiment of the present invention, and

FIG. 4 is a sectional view of the bead part of a tire according to the third embodiment of the present invention.

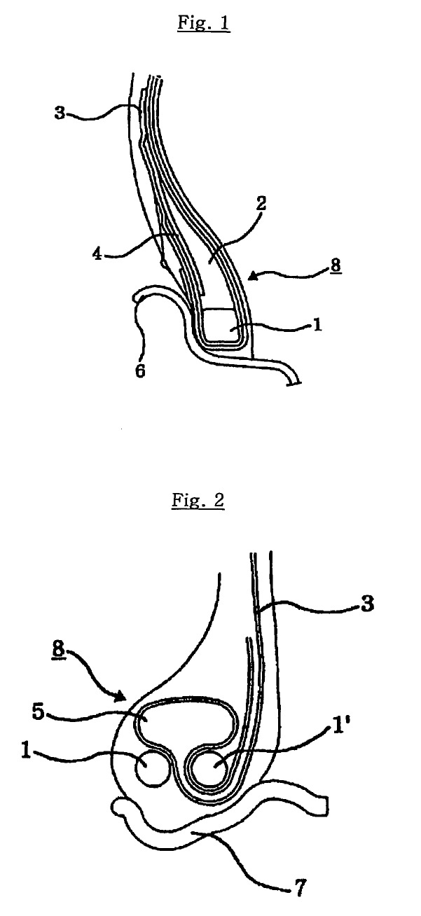

### EXPLANATION OF MARKS IN THE FIGURES

| | |
|---|---|
| 1, 1′: bead, | 2: apex |
| 3: carcass ply | 4: insert |
| 5, 5′: rubber lump | 6: flange |
| 7: bead sheet | 8: bead portion |

### BEST MODE FOR CARRYING OUT THE INVENTION

To achieve the object as stated above, a rubber lump is installed between two beads which are arranged doubly, or two fold lumps are placed enclosing a single bead, the lump having the role that the bead part is not easily released from the bead sheet of the rim when the tire is deflated.

The construction of the pneumatic tire having reinforced bead part of the present invention will be described in detail with reference to the accompanying drawings.

FIG. 2 is a cross-sectional view of the bead portion of the tire according to the first embodiment of the present invention, wherein two beads 1, 1′ are placed facing each other with predetermined interval in the bead part 8 which is arranged on a bead sheet, a rubber lump 5 is installed on said two beads passing through the beads, and a carcass ply 3 winds around said rubber lump 5.

Now the process of manufacturing the bead part to which a rubber lump 5 is applied will be described.

A carcass ply 3 is installed winding on the molding drum and a rubber lump 5 winds at an arbitrary point between both ends and center portion of the carcass ply 3, and the carcass ply 3 is turned up. Among two beads, the first bead 1 is placed at the front of the rubber lump 5 and the second bead 1′ is placed at the rear of the rubber lump 5.

Accordingly, when the tire is deflated or under-inflated while driving, the carcass ply 3 is pulled toward the side of the tire, and due to this force the rubber lump 5 between two beads 1, 1′ can prevent the bead part 8 from releasing from the bead sheet 7. In this way the problem of prior art tire that the bead part is easily released from the rim due to the movement of bead part from bead sheet of the rim to wall area when the tire is deflated can be solved.

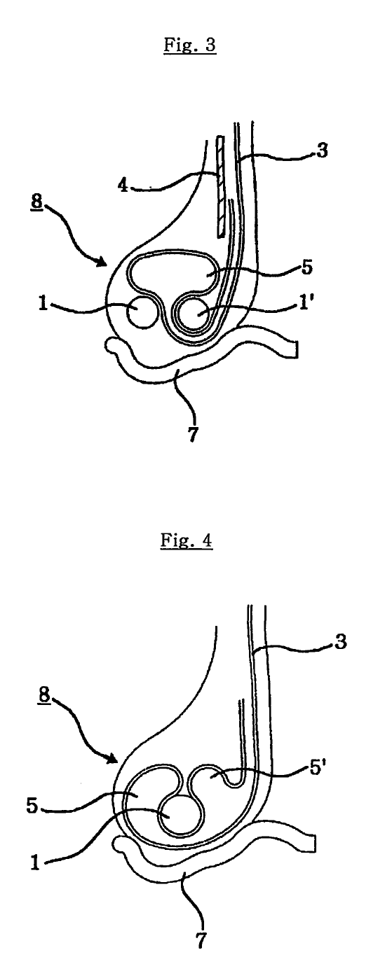

FIG. 3 is a cross-sectional view of the bead part of the tire according to the second embodiment of the present invention, wherein a steel insert 4 is inserted on the rubber lump 5 parallel to the carcass ply 3, so that the release of bead part from bead sheet becomes more difficult.

FIG. 4 is a cross-sectional view of the bead portion of the tire according to the third embodiment of the present invention, wherein two fold rubber lumps 5, 5′ are installed enclosing the single bead 1. The basic principle is the same as that of the first embodiment, the two fold rubber lump 5, 5′ preventing the movement of bead 1 when the tire is deflated.

### Industrial Applicability

By using the pneumatic tire with reinforced bead part of the present invention in a tire without flange, the bead part is not easily released from the rim when the tire is deflated or under-inflated while driving, and the function of the tire is not affected. Therefore, the car accidents caused by released bead part can be prevented.

What is claimed is:

1. A pneumatic tire with reinforced bead part, wherein two beads 1, 1′ are placed facing each other with predetermined interval in the bead part 8 which is arranged on a bead sheet, a rubber lump 5 is installed on said two beads passing through the beads, and a carcass ply 3 winds around said rubber lump 5.

2. A pneumatic tire with reinforced bead part, wherein a bead 1 is placed in the bead part 8 which is arranged on a bead sheet, two fold rubber lumps 5, 5′ are installed on both sides of said bead, and a carcass ply 3 winds around said rubber lumps 5, 5′.

3. The pneumatic tire with reinforced bead part of claim 1 or claim 2, wherein an insert 4 is inserted on the rubber lump 5 parallel to the carcass ply 3.
